(19) United States
(12) Patent Application Publication
(10) Pub. No.: US 2018/0355975 A1
(43) Pub. Date: Dec. 13, 2018

(54) FLUID COUPLING ASSEMBLY

(71) Applicant: Deublin Company, Waukegan, IL (US)

(72) Inventor: Anton A. Petrou, Hawthorn Woods, IL (US)

(21) Appl. No.: 15/995,934

(22) Filed: Jun. 1, 2018

Related U.S. Application Data
(60) Provisional application No. 62/516,424, filed on Jun. 7, 2017.

(51) Int. Cl. F16J 15/16; F16L 37/22; F16L 37/14

(52) U.S. Cl. CPC F16J 15/16; F16H 2045/0278; F16L 37/146; F16L 37/22

(57) ABSTRACT

A fluid coupling assembly includes a sliding seal interface between rotating and non-rotating components, through which a fluid conduit extends. A flow of fluid is provided through the fluid conduit during operation. A hydrocyclone device has a body forming a cyclone chamber, the cyclone chamber having a feed opening, a base opening and an apex opening. A flow constrictor is disposed along the fluid conduit between an upstream portion and a downstream portion of the fluid conduit. The feed opening is fluid connected to the upstream portion of the fluid conduit and the apex opening is fluidly connected to the downstream portion of the fluid conduit. The base opening is fluidly connected to a passage having an outlet adjacent the sliding seal interface.

### CROSS-REFERENCE TO RELATED APPLICATIONS

The present application claims the benefit of U.S. Provisional Patent Application Ser. No. 62/516,424, filed on Jun. 7, 2017, which is incorporated herein in its entirety by this reference.

### TECHNICAL FIELD

The present invention relates to fluid coupling assemblies such as rotary unions and will be particularly described in relation to an extended life swivel seal assembly and, more specifically, to an extended life swivel seal assembly for use in a fluid coupling for high speed geological drilling operations.

### BACKGROUND

Fluid coupling assemblies are used in industrial applications, for example, in high speed drilling operations where it is necessary to couple the outlet of a fluid source to a rotating device, machining of metals or plastics, work holding, printing, plastic film manufacture, papermaking, semiconductor wafer manufacture, and other industrial processes that require a fluid medium to be transferred from a stationary source such as a pump or reservoir into a rotating element. Often these applications require high media pressures and flow rates.

Fluid coupling assemblies used in such applications convey fluid medium used by the equipment for drilling, cooling, heating, or for actuating one or more rotating elements. Typical fluid media include water-based liquids or slurries, or hydraulic or cooling oils. Machines using fluid coupling devices typically include components that are expensive and/or difficult to repair or replace during service. These components are often subject to corrosive environments or to damage.

Specifically, in oil and gas drilling operations, fluid coupling assemblies, often called “swivel seal assemblies,” are utilized to provide a sealing arrangement between the washpipe and the rotating sealing housing. One type of a drilling rig swivel seal assembly utilizes a stack of rotary seals which are typically comprised of reinforced elastomeric material that provide a dynamic sealing arrangement with the external cylindrical sealing surface of the washpipe. In certain applications, the working fluid is a mud slurry. In such designs, the seals and their housings rotate relative to the stationary washpipe, and the seals are sequentially exposed to the high pressure drilling fluid on one side of the seal and atmospheric pressure on the other side of the seal. This differential pressure causes the seal closest to the high pressure to grab tightly against the washpipe, thereby causing a high degree of wear and abrasion to the washpipe and the seal. The wear and abrasion is exacerbated by grit particles from the mud slurry that enter the sliding interface between the rotary seals.

The relatively large clearance required between the rotating seal and the washpipe results in ultimate failure of the seal. Additionally, because of the stacked relation of the seals to the washpipe, once the first seal fails, the next seal in the stack is exposed to similar forces and wear, and so on, until all the seals have been consumed by the severe abrasive operating conditions. Such rotary seal members are also structurally complex, are time consuming and difficult to replace, and have a limited lifetime of approximately 200 hours or less when operating at 90 RPM and up to 2,500 PSI. When such seal assemblies are operated at 5,000 PSI and at 250 RPM, such seals last only between 20 and 30 hours before replacement is necessary.

An additional sealing arrangement is the utilization of complex U-shaped cup ring sealing assemblies between the washpipe and the rotating seal assembly. However, such sealing assemblies also have a limited lifetime and require significant replacement costs due to wear and abrasion which results in extended downtime of the drilling swivel seal assembly.

It has also been suggested to provide a floating seal member attached to the rotating coupling member and a similar seal member mounted to the non-rotating coupling member to provide a seal assembly for a drilling rig swivel assembly. Such seal assemblies further include a secondary seal member comprised of a U-cup seal member between the distal end of the washpipe member and the floating seal member. However, because the U-cup seal member is exposed to the high pressure abrasive drilling fluid, such contact results in the rapid wear and ultimate failure of such fluid coupling assemblies.

### SUMMARY

In one aspect, the disclosure describes a fluid coupling assembly. The fluid coupling assembly includes a rotatable component, a first sealing ring engaged with the rotatable component, the first sealing ring being rotatably constrained to the rotatable component, and a non-rotatable component having a second sealing ring engaged with the non-rotatable component, the second sealing ring abutting the first sealing ring to create a sliding seal interface therebetween. A fluid conduit is defined that extends through the rotatable component, the first sealing ring, the second sealing ring and the non-rotatable component. During operation, a flow of fluid is provided through the fluid conduit. The fluid coupling assembly further includes a hydrocyclone device having a body forming a cyclone chamber, the cyclone chamber having a feed opening, a base opening and an apex opening. A flow constrictor is disposed along the fluid conduit between an upstream portion and a downstream portion of the fluid conduit. The feed opening is fluidly connected to the upstream portion of the fluid conduit, and the apex opening is fluidly connected to the downstream portion of the fluid conduit. The base opening is fluidly connected to a passage having an outlet adjacent the sliding seal interface.

In another aspect, the disclosure describes a method for operating a fluid coupling assembly. The method includes providing an assembly having a rotating component that rotates relative to a non-rotating component, creating a sliding seal interface between the rotating and non-rotating components, and providing a flow of fluid through a fluid conduit extending through and between the rotating and non-rotating components. The method further includes fluidly connecting a hydrocyclone in fluid communication with the fluid conduit, the hydrocyclone including a feed opening, a base opening and an apex opening in fluid communication with a cyclone chamber, diverting a portion of the flow of fluid, and providing the portion of the flow of fluid to the cyclone chamber through the feed opening. The method also includes separating the portion of the flow of fluid in the cyclone chamber into a heavy material flow, which is expelled from the apex opening of the cyclone chamber, and a light material flow, which is expelled from the base opening of the cyclone chamber, and routing the light material flow to an area adjacent the sliding seal interface.

In yet another aspect, the disclosure describes an insert for a fluid coupling assembly, which includes a flange and a body connected to the flange. The body has a generally cylindrical shape and includes a through opening extending through the body and a channel extending peripherally around the body at a distance from the flange. A plurality of hydrocyclones is formed in the body, each of the plurality of hydrocyclones including a cyclone chamber defined in the body, the cyclone chamber having a feed opening, a base opening and an apex opening. In one embodiment, the feed opening is fluidly connected to a feed passage formed in the body and communicates with an inlet opening formed in a surface of the flange that is opposite the body portion, the base opening is fluidly connected to a water passage formed in the body and communicates with an outlet opening formed in a lateral surface of the body that is disposed within the channel, and the apex opening fluidly communicates with a heavy material discharge formed in an end surface of the body opposite the flange.

### BRIEF DESCRIPTION OF THE DRAWINGS

FIG. 1 a longitudinal, cross-sectional view of a known floating swivel seal assembly to illustrate the various known structures.

FIG. 2 is a longitudinal, cross sectional view of an extended life floating swivel seal assembly in accordance with the disclosure.

FIG. 3 is an enlarged, detail cross-section of the seal assembly shown in FIG. 2, which includes diagrammatic representations of the various material flows through the assembly in accordance with the disclosure.

FIG. 4 is a schematic representation of an alternative embodiment for a seal assembly that includes an external hydrocyclone arrangement in accordance with the disclosure.

FIG. 5 is a perspective view of a first seal ring, and FIG. 6 is an enlarged detail view of a section of the first seal ring in accordance with the disclosure.

FIG. 7 is a perspective view of a second seal ring, and FIG. 8 is an enlarged detail view of a section of the second seal ring in accordance with the disclosure.

FIG. 9 is a flowchart for a method in accordance with the disclosure.

### DETAILED DESCRIPTION

This disclosure relates to fluid coupling assemblies such as a seal assembly used in a water based drilling mud swivel seal assembly. As will be understood by those skilled in the art, this disclosure can be adapted for use with conventional rotary unions that typically include a stationary member, sometimes referred to as the housing, which has an inlet port for receiving fluid medium. In an exemplary rotary union, a non-rotating seal member is mounted within the housing. A rotating member, which is sometimes referred to as a rotor, includes a rotating seal member and an outlet port for delivering fluid to a rotating component. A seal surface of the non-rotating seal member is biased into fluid-tight engagement with the seal surface of the rotating seal member, generally by a spring, media pressure, or other method, thus enabling a seal to be formed between the rotating and non-rotating components of the union. The seal permits transfer of fluid medium through the union without significant leakage between the non-rotating and rotating portions.

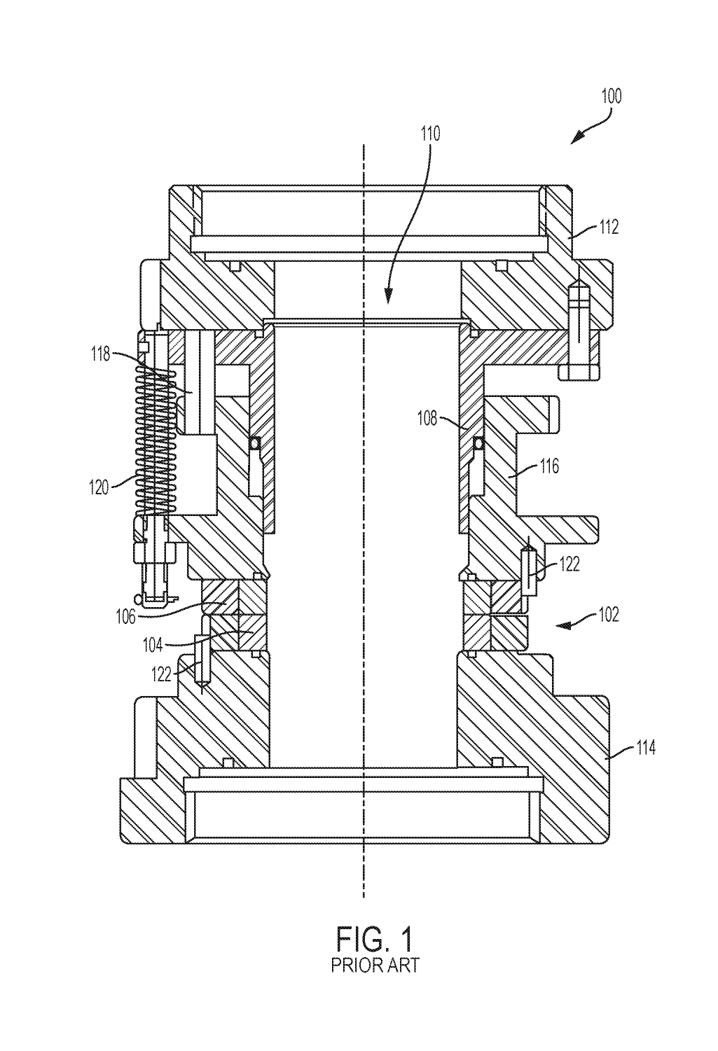

For sake of brevity, the disclosure will be described in relation to a swivel seal assembly, though it should be understood that the disclosure has application to other fluid coupling devices such as rotating unions used with equipment such as computer-numerical-control (CNC) milling machines, turning machines, and so forth. A swivel seal assembly 100 is shown in FIG. 1 to illustrate the main components of a seal assembly of the type. The swivel seal assembly 100 includes a stack of sealing rings 102, each of which includes an elastomeric seal portion 104 surrounded by a reinforcement ring 106, which may be made of steel. The sealing rings 102, one of which is rotating and the other being stationary, are disposed at the end of a washpipe 108 that is part of a fluid conduit 110 that carries a drilling fluid such as drilling mud and is segmented across various components and pipes. The swivel seal assembly 100 conducts abrasive drilling fluid from a non-rotating hose 112 to a rotating drill string 114. As shown in FIG. 1, the sealing rings 102 are stacked between rotating and non-rotating structures to provide a mechanical face seal to retain the abrasive drilling fluid within the fluid conduit 110.

A floating seal guide member 116 is aligned with the washpipe and configured to slidably and sealably engage therewith to control a loading applied onto the sliding seal interface. Pins 118 and a spring 120 axially constrain and bias the floating seal guide member 116 and, thus, the sealing rings 102, towards one another. Anti-rotation pins 122 rotatably engage a respective one of the sealing rings 102 with the guide member 116 and the rotating drill string 114 to ensure that one sealing ring rotates with the drill string and the other remains rotationally stationary and engaged with the guide member 116.

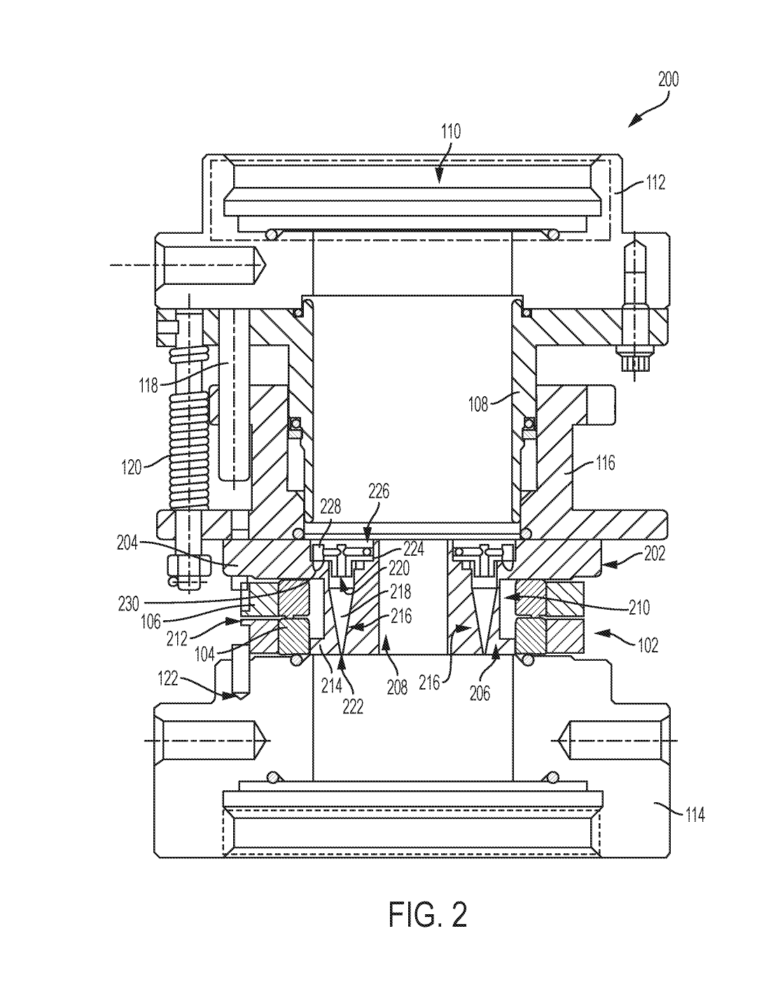

A cross section of a swivel seal assembly 200 in accordance with the disclosure is shown in FIG. 2, where the same or similar structures and features corresponding to the swivel seal assembly 100 shown in FIG. 1 are denoted by the same reference numerals previously used for simplicity. In the swivel seal assembly 200, the sealing rings 102 are stacked beneath a non-rotating insert 202, as described hereinafter. The insert 202 includes a flange portion 204 and a body portion 206. The flange portion 204 abuts an end of the guide member 116 and is disposed axially along a centerline of the fluid conduit 110 between the guide member 116 and the adjacent one of the sealing rings 102. The body portion 206 has a generally cylindrical shape forming a through-opening 208. The body portion 206 defines an outer diameter of a cylindrical wall that, at least partially along an axial length of the body portion 206, is less than a corresponding inner diameter of the fluid conduit 110 such that a gap 210 is formed that extends radially inwardly from the inner wall of the fluid conduit 110 that overlaps a sliding seal interface 212 between the sealing rings 102, and also extends radially outwardly from the outer diameter of the cylindrical wall of the body portion 206. In the illustrated embodiment, the gap 210 is bound on both axial ends to define a hollow cylindrical chamber that overlaps at least the sliding ring seal interface 212. One bound is defined by a surface of the flange portion 204 that is opposite the end of the guide member 116, and the second bound is defined by a lower flange 214 such that the gap 210 is formed as a channel extending peripherally around and into the outer surface of the cylindrical body 206 along an axial length that includes at least the interface 212.

Advantageously formed in the cylindrical body 206 are one or more hydrocyclones 216, which in an embodiment are arranged symmetrically around a periphery of the through opening 208. In the illustrated embodiment, the hydrocyclones 216 are integrated with, formed within, or otherwise associated with the body portion 206 of the insert 202. As shown in the cross section of FIG. 2, each hydrocyclone 216 includes a cyclone chamber 218 having a base opening 220, which operates as the overflow, and an apex opening 222, which operates as the underflow, relative to a flow direction of mud within the fluid conduit 110. Fluid from the fluid conduit 110 is provided into the cyclone chamber 218 through a tangential opening 224, which is formed in the body portion 206 adjacent and around the apex opening 222, and which operates as a feed opening. The fluid enters a passage 228 that is fluidly connected to the tangential opening 224 through an inlet port 226, which is formed in the surface of the body portion 206 or the flange 204 that faces and is in the path of fluid flow through the fluid conduit 110. More than one inlet port 226 may correspond to each hydrocyclone, and the passage for fluid from the inlet port(s) 226 to the tangential opening 224 may be routed in any desired fashion to create a desired swirling of fluid within the cyclone chamber 218. The base opening 220 is fluidly connected via a passage 228 formed in the body portion 206 to a water outlet 230, which is fluidly open to the gap 210. Those skilled in the art can appreciate that such hydrocyclones can be adapted to similar structures in a rotary union such as typically used with high-speed machining equipment.

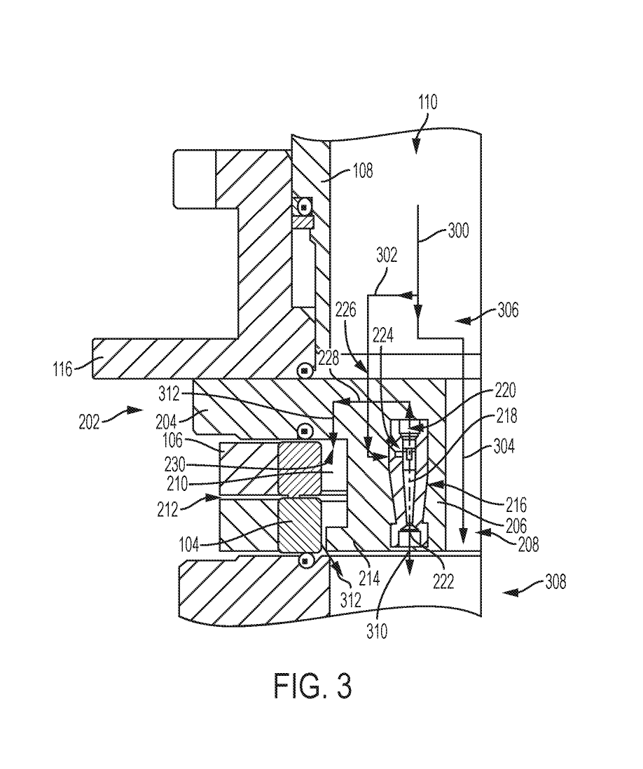

In the embodiment illustrated in FIG. 2, and consistent with hydrocyclone devices of much larger size, the cyclone chamber 218 is defined within a generally conical space having a base and an apex, into which an aqueous slurry of mud from the fluid conduit 110 is introduced during operation. An array of hydrocyclones may be arranged around a portion of the fluid conduit 110. Each hydrocyclone 216 operates to separate at least some of the grit particles of the aqueous mud slurry from their water carrier, and provide relatively clean water to cool and lubricate the sliding rings while the heavier grit particles are reintroduced into the mud flow passing through the fluid conduit 110. In the case of hydrocyclones used with high-speed machining equipment, the hydrocyclones could be used to separate grit and other undesirable particles from recirculating coolants or lubricants. In the schematic view shown in FIG. 3, where like or similar features are denoted by the same reference numerals as previously used for simplicity, a circuit representation of the operation of the hydrocyclones is illustrated.

In reference to FIG. 3, and as illustrative of applications of the disclosure to fluid coupling assemblies in general, a main flow of fluid 300 passes through the fluid conduit 110 during operation. The fluid is an aqueous mud slurry, which may include grit particles and other substances suspended in a generally aqueous carrier. A portion 302 of the main flow of fluid 300 is separated from a remaining flow 304. The remaining flow 304 passes the through opening 208, which has a smaller cross-sectional area for flow as compared to the preceding and following portions of the fluid conduit 110. Thus, the through opening 208 causes a flow restriction that creates a higher pressure of fluid at an upstream end 306 and a lower pressure of fluid at a downstream end 308.

The pressure difference between the upstream and downstream ends 306 and 308 drives the portion 302 of fluid to enter the passage 228 through the inlet port 226 and, in turn, to enter the cyclone chamber 218 of each respective hydrocyclone 216 via each corresponding feed or tangential opening 224. Within the chamber, cyclonic action causes a separation of at least some of the heavier grit components from the portion 302, which collect into a heavier mud flow 310 that exits the chamber through the apex opening 222 and rejoins the remaining portion 304 of the flow. Lighter compounds and water exit the chamber through the base opening 220 and are carried via passage 228 to the water outlet 230.

The lighter compounds and water 312 exiting the water outlet 230 collect in the gap 210 and displace the heavier mud slurry from the main flow 300 that would have otherwise occupied this space, and provide a more favorable environment for operation of the sealing rings 102. Specifically, by providing water or, at least, thinner drilling mud around the area of the seals, large, abrasive mud particles are diverted from reaching the sliding interface between the sealing rings to reduce abrasive wear of the sealing rings and to prolong their service life. This is accomplished by separating and providing water to the seals in situ, which also operates to cool and lubricate the sealing rings. Due to the pressure difference across the device provided by the throttling function of the through opening 208, a constant flow of water or, at least, a thinner aqueous solution is provided in a positive flow arrangement into the gap 210. Excess fluid from the flow 312 exits the gap 210 around the lower flange 214, which is sized such that ingress of heavier mud into the gap 210 is countered by the flow of water or thinner slurry 312. Further, it can be appreciated that the only fluid pressure to which the system is exposed to is the pressure difference created by the through opening 208 and not the operating, system pressure because the structures and passages are all internal to the device. This same arrangement can be applied to other fluid coupling assemblies to lubricate the sealing rings to reduce abrasion and wear.

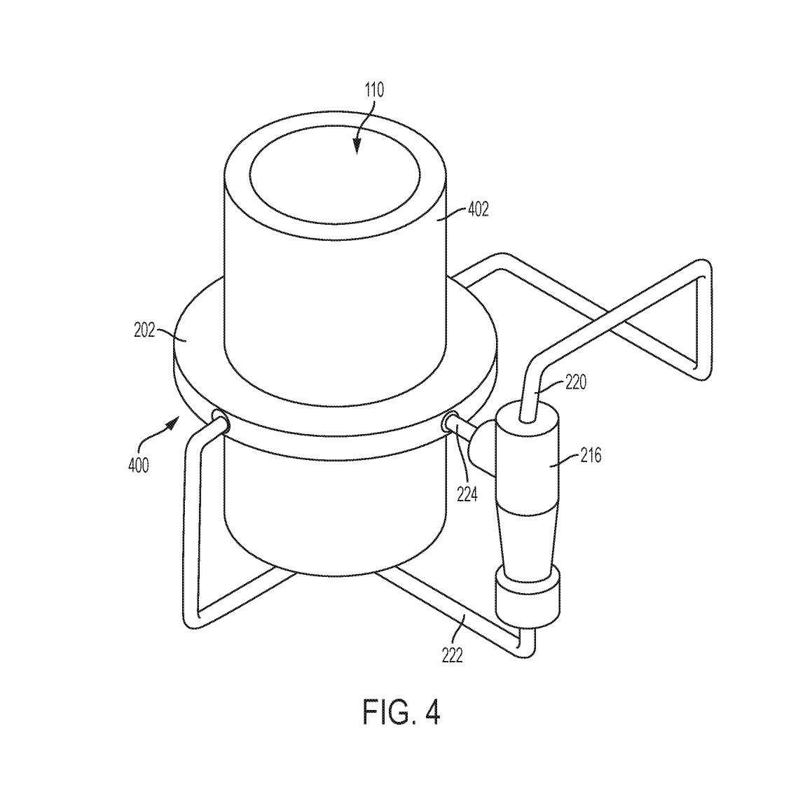

An alternative embodiment showing an external packaging of a hydrocyclone 216 is shown in the schematic view of FIG. 4, where like or similar structures are again denoted by the same reference numerals previously used for simplicity. In this embodiment, a fluid manifold 400, which encompasses the sealing rings 102 and also forms internally a through opening 208, is disposed externally relative to a pipe section 402 that forms the fluid conduit 110. In an operating principle that is identical to that described above relative to FIG. 3, a portion of the mud flow through the fluid conduit 110 is separated and provided to a feed or tangential opening 224 of the hydrocyclone 216, where it is separated into a heavy mud flow that is reintroduced into the main flow via an apex opening 222 conduit, and a lighter mud or water flow that is provided through a base opening 220 conduit to cool and lubricate the sealing rings. As can be appreciated, the various conduits and structure of the hydrocyclone 216 in this embodiment are exposed to a gauge system pressure differential.

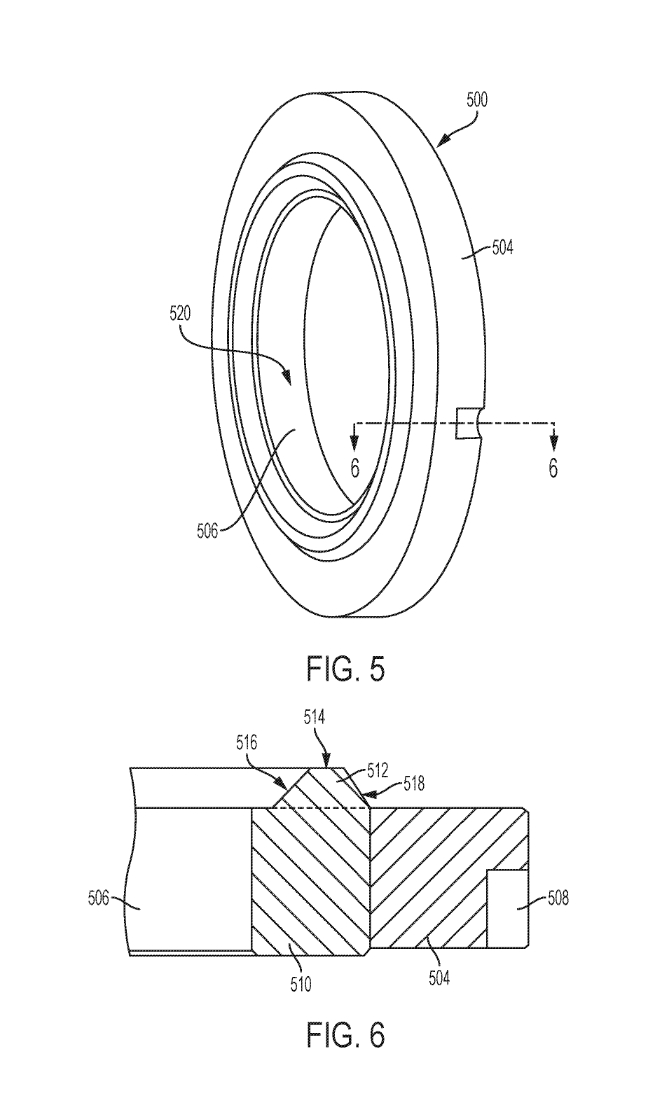

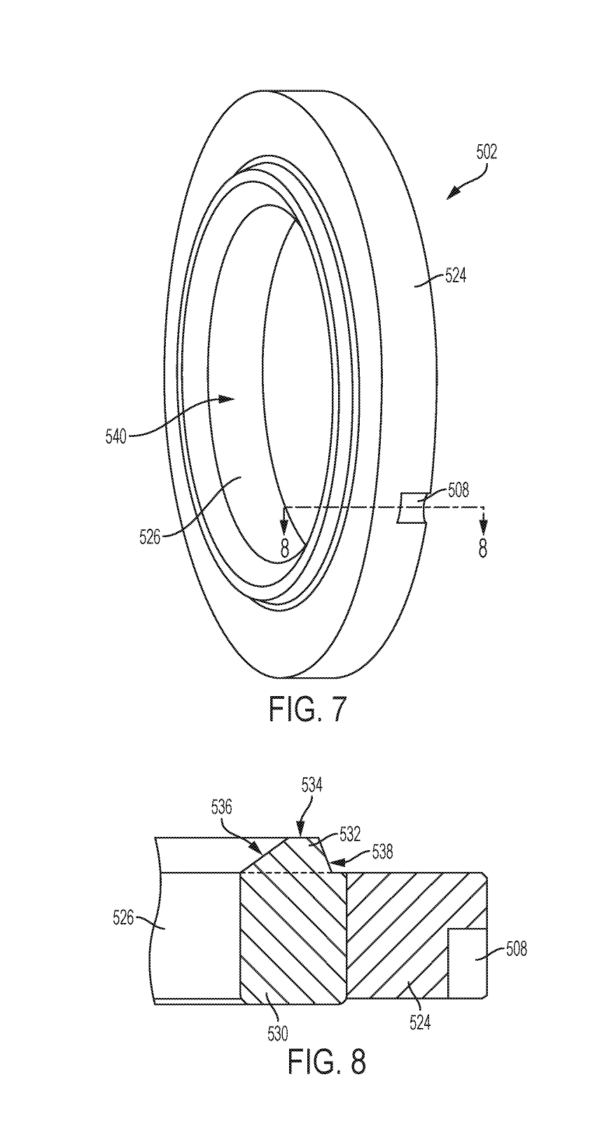

FIGS. 5 and 6 show perspective and enlarged cross section views of a first sealing ring 500, respectively, and FIGS. 6 and 7 similarly illustrate a second sealing ring 502. The first and second sealing rings 500 and 502 advantageously include features that further prolong the life of the sealing rings by providing a controlled sealing material wear configuration that results in creating a useful seal between the rings over a greater wear extent than was previously possible. In the illustrated embodiment, the seals are capable of maintaining a flatness of the seal face within 2-3 helium light bands (0.0000232 inches) over 1000 hours of operation under a pressure of 5000 psi and a speed of 150 revolutions per minute at a continuous temperature of 150 deg. F (250 deg. F Max) while a flow rate of 100 gallons per minute passes through the device.

More specifically, the first sealing ring 500 includes an outer ring 504 that surrounds an inner ring 506. As shown, the outer ring 504 may be constructed of metal such as stainless steel, and the inner ring 506 may be constructed of an appropriate sealing material such as a polymer or a polymer-based composite material such as the material available in commerce under the name Celazole® TL-60, available from PBI Performance Products, Inc. of Charlotte, N.C. (www.CelazolePBI.com), or another appropriate material depending on the application. The outer ring 504 includes recesses 508 into which pins (not shown) are inserted to either prevent rotation of the ring relative to a stationary component or to rotatably engage the ring to a rotating structure. The inner ring 506 includes a base portion 510, which has a generally rectangular cross section, and a sealing portion 512, which has a generally trapezoidal cross section.

The sealing portion 512 presents an annular sealing face 514 that protrudes past the base portion 510 and is surrounded by two conical surfaces extending radially inwardly and outwardly. As shown in FIG. 6, the annular sealing face 514 is disposed radially outwardly from an inner conical surface 516 that is angled radially inward at an appropriate angle that produces a first balance ratio when the sealing ring is placed in service. An outer conical surface 518 is disposed radially outwardly from the annular sealing face 514 and is inclined radially outwardly, as shown in FIG. 6. The inclination angle of the inner conical surface 516 in the illustrated embodiment creates a balance ratio of about 60% for the first sealing ring 500. Moreover, the inclination angle of the inner conical surface 516 is different than an inclination angle of the outer conical surface 518, which produces an asymmetric conical shape that helps extend an allowable extent of wear. The first ring 500 further includes a central opening 520, which forms or surrounds a portion of the fluid conduit (e.g., the fluid conduit 110 as shown in FIG. 2) when the ring is installed in a device, as described above.

Similar to the first sealing ring 500, the second sealing ring 502 includes an outer ring 524 that surrounds an inner ring 526. As shown, the outer ring 524 may be constructed of metal such as stainless steel, and the inner ring 526 may be constructed of an appropriate sealing material such as a polymer or a polymer-based composite material, similar to the inner ring of the first sealing ring or another appropriate material depending on the application. Like the outer ring 504 of the first sealing ring 500, the outer ring 524 of the second sealing ring 502 includes recesses 508 into which pins (not shown) are inserted to either prevent rotation of the ring relative to a stationary component or to rotatably engage the ring to a rotating structure. The inner ring 526 includes a base portion 530, which has a generally rectangular cross section, and a sealing portion 532, which has a generally trapezoidal cross section.

The sealing portion 532 presents an annular sealing face 534 that protrudes past the base portion 530 and is surrounded by two conical surfaces radially extending inwardly and outwardly. As shown in FIG. 8, the annular sealing face 534 is disposed radially outwardly from an inner conical surface 536 that is angled radially inward at an appropriate angle that produces a second balance ratio when the sealing ring in placed in service. An outer conical surface 538 is disposed radially outwardly from the annular sealing face 534 and is inclined radially outwardly, as shown in FIG. 8. The inclination angle of the inner conical surface 536 in the illustrated embodiment creates a balance ratio of about 80% for the second sealing ring 502. Moreover, as is the case with the first sealing ring 500, the inclination angle of the inner conical surface 536 is different than an inclination angle of the outer conical surface 538 in the second sealing ring 502, which also produces an asymmetric conical shape that helps extend the useful life of the seal face. The second sealing ring 502 further includes a central opening 540, which forms or surrounds a portion of the fluid conduit (e.g., the fluid conduit 110 as shown in FIG. 2) when the ring is installed in a device, as described above.

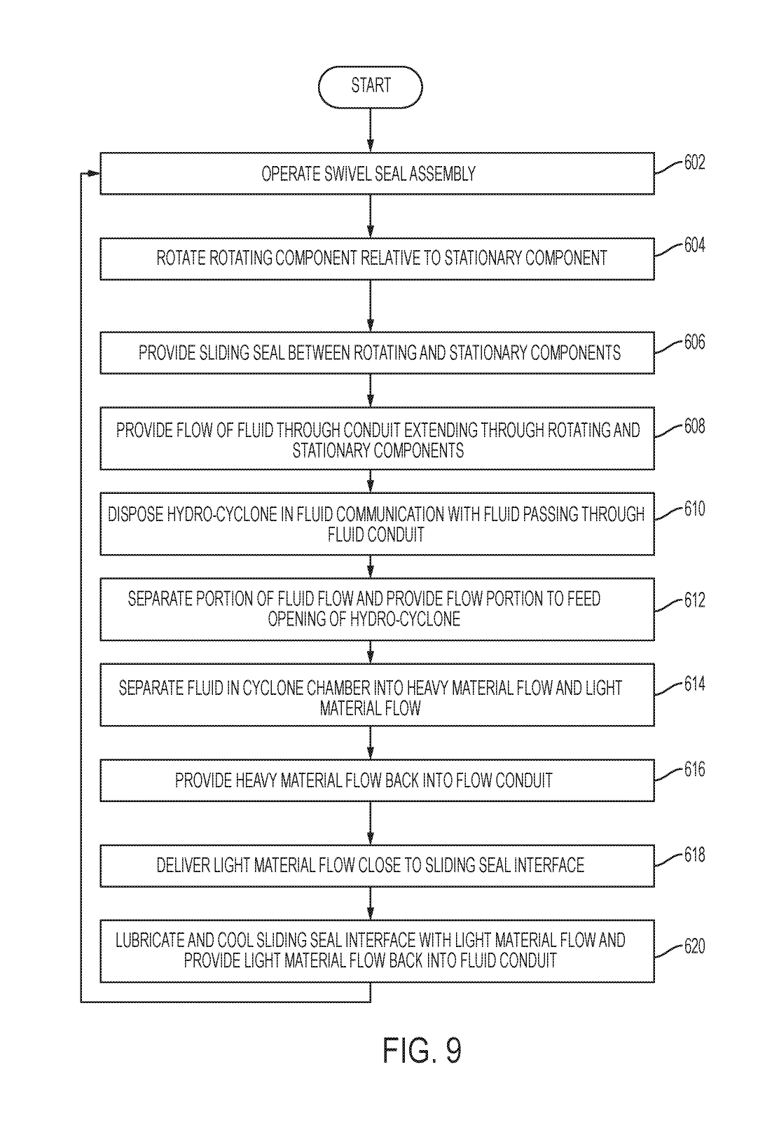

A flowchart for a method of operating a swivel seal assembly is shown in FIG. 9. This method can advantageously be applied to other fluid coupling assemblies. In accordance with the method, and as disclosed in FIG. 9, the swivel seal assembly is operated at 602. Operation of the swivel assembly includes rotating a rotating component relative to a stationary component at 604, providing a sliding seal between the rotating and stationary components at 606, and further providing a flow of fluid through a conduit extending through the rotating and stationary components at 608. In one embodiment, the sliding seal is created between a rotating sealing ring that is rotationally attached to the rotating component, and a non-rotating sealing ring that is rotationally attached to the non-rotating component. Further, in one embodiment, particularly in a drilling operation, the fluid that is provided through the conduit may be an aqueous slurry that includes water, grit and, optionally, additives.

The method further includes disposing a hydrocyclone in fluid communication with the fluid passing through the conduit at 610, which includes providing a hydrocyclone having a cyclone chamber that is fluidly in communication with a feed opening, a base opening and an apex opening in fluid communication with the fluid conduit. During operation, the method further includes separating a portion of the flow of fluid passing through the fluid conduit, and providing the portion of the flow to the hydrocyclone through the feed opening at 612. At 614, fluid entering the cyclone chamber separates into a heavy material flow that exits the apex opening and a light material flow that exits the base opening. The fluid is urged to pass into and through the cyclone cavity under a pressure difference that is created within the fluid conduit across at least the feed opening and the apex and/or base openings of the hydrocyclone. The heavy material flow is routed back into the fluid conduit to mix with a remaining portion of the fluid flow at 616. The light material flow is routed and delivered close to the sliding seal interface at 618 to lubricate and cool the sealing components that create the sliding seal interface. At 620, the light material flow is also provided back into the fluid conduit after it has washed over the sliding seal interface. The process of separating a portion of the flow, at least partially, into its constituents, continues while the device is operating and while a flow of fluid is provided through the fluid conduit.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. Specifically, preferred embodiments of this disclosure are described herein, including the best mode known to the inventor at this time for carrying out the disclosure. Variations of those preferred embodiments may become apparent to those of ordinary skill in the art upon reading the foregoing description. The inventor expects skilled artisans to employ such variations as appropriate, and the inventor intends for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

I claim:

1. A fluid coupling seal assembly, comprising:
a rotatable component;
a first sealing ring engaged with the rotatable component, the first sealing ring being rotatably constrained to the rotatable component;
a non-rotatable component;
a second sealing ring engaged with the non-rotatable component, the second sealing ring abutting the first sealing ring to create a sliding seal interface therebetween;
wherein a fluid conduit is defined that extends through the rotatable component, the first sealing ring, the second sealing ring and the non-rotatable component, and wherein, during operation, a flow of fluid is provided through the fluid conduit;
a hydrocyclone device having a body forming a cyclone chamber, the cyclone chamber having a feed opening, a base opening and an apex opening;
a flow restrictor, the flow restrictor disposed along the fluid conduit between an upstream portion and a downstream portion of the fluid conduit;
wherein the feed opening is fluid connected to the upstream portion of the fluid conduit and the apex opening is fluidly connected to the downstream portion of the fluid conduit; and
wherein the base opening is fluidly connected to a passage having an outlet adjacent the sliding seal interface.

2. The fluid coupling assembly of claim 1, further comprising an insert, the insert comprising:
a flange portion disposed between the non-rotatable component and the second sealing ring; and
a body portion connected to the flange portion and disposed within the fluid conduit, the body portion having a through opening separating the upstream and downstream portions,
wherein the through opening is the flow restrictor, and
wherein the body portion forms an annular cavity adjacent the sliding seal interface.

3. The fluid coupling assembly of claim 2, wherein the hydrocyclone device is integrated into the body portion.

4. The fluid coupling assembly of claim 3, further comprising a plurality of hydrocyclone devices integrated into the body portion, each of the plurality of hydrocyclone devices being connected in parallel fluid connection along the fluid conduit between the upstream and downstream portions.

5. The fluid coupling assembly of claim 2, wherein a substantially closed, annular cavity is formed in the body portion at least adjacent the sliding seal interface, and wherein the passage fluidly connects the base opening with the annular cavity.

6. The fluid coupling assembly of claim 5, wherein the annular cavity forms a gap configured to contain a light flow of material from the hydrocyclone device during operation.

7. The fluid coupling assembly of claim 1, wherein fluid in the flow of fluid is an aqueous slurry containing water and grit to form a mud, and wherein, during operation, the hydrocyclone device is configured to separate the flow of fluid provided through the feed opening into a heavy flow of fluid, which exits the cyclone chamber through the apex opening, and a heavy flow of fluid, which exits the cyclone chamber through the base opening.

8. The fluid coupling assembly of claim 1, wherein the first sealing ring includes a first outer ring and a first inner ring, the first inner ring comprising a first base portion and a first sealing portion, the first base portion having a generally rectangular cross section, and the first sealing portion having a first generally asymmetrical trapezoidal cross section.

9. The fluid coupling assembly of claim 8, wherein the second sealing ring includes a second outer ring and a second inner ring, the second inner ring comprising a second base portion and a second sealing portion, the second sealing portion having a second generally asymmetrical trapezoidal cross section.

10. The fluid coupling assembly of claim 9, wherein the first and second generally asymmetrical trapezoidal cross sections are different so as to provide different balance ratios to the first and second sealing rings when a fluid pressure from the flow of fluid in the fluid conduit is present.

11. A method for operating a fluid coupling assembly, comprising:
providing a rotating component that rotates relative to a non-rotating component;
creating a sliding seal interface between the rotating and non-rotating components;
providing a flow of fluid through a fluid conduit extending through and between the rotating and non-rotating components;
fluidly connecting a hydrocyclone in fluid communication with the fluid conduit, the hydrocyclone including a feed opening, a base opening and an apex opening in fluid communication with a cyclone chamber;
diverting a portion of the flow of fluid, and providing the portion of the flow of fluid to the cyclone chamber through the feed opening;
separating the portion of the flow of fluid in the cyclone chamber into a heavy material flow, which is expelled from the apex opening of the cyclone chamber, and a light material flow, which is expelled from the base opening of the cyclone chamber; and
routing the light material flow to an area adjacent the sliding seal interface.

12. The method of claim 11, further comprising lubricating and cooling the sliding seal interface with the light material flow.

13. The method of claim 11, further comprising containing the light material flow in the area adjacent to the sliding seal interface.

14. The method of claim 11, further comprising constricting the flow of fluid to create a pressure differential across the hydrocyclone.

15. The method of claim 14, wherein creating the sliding seal interface is accomplished by connecting a first sealing ring to the rotating component and a second sealing ring to the non-rotating component.

16. The method of claim 15, wherein the first sealing ring and the second sealing ring have different balance ratios.

17. The method of claim 15, wherein constricting the flow of fluid is accomplished by using an insert, the insert comprising:
a flange portion disposed between the non-rotating component and the second sealing ring; and
a body portion connected to the flange portion and disposed within the fluid conduit, the body portion having a through opening separating the upstream and downstream portions, wherein the through opening is a flow restrictor.

18. The method of claim 17, wherein the hydrocyclone is integrated into the body portion.

19. The method of claim 18, further comprising a plurality of hydrocyclones integrated into the body portion, each of the plurality of hydrocyclones being connected in parallel fluid connection along the fluid conduit.

20. An insert for a fluid coupling assembly, comprising:
a flange; and
a body connected to the flange, the body having a generally cylindrical shape and including a through opening extending through the body and a channel extending peripherally around the body at a distance from the flange;
a plurality of hydrocyclones formed in the body, each of the plurality of hydrocyclones including a cyclone chamber defined in the body, the cyclone chamber having a feed opening, a base opening and an apex opening,
wherein the feed opening is fluidly connected to a feed passage formed in the body and communicating with an inlet opening formed in a surface of the flange that is opposite the body;
wherein the base opening is fluidly connected to a water passage formed in the body and communicating with an outlet opening formed in a lateral surface of the body that is disposed within the channel; and
wherein the apex opening fluidly communicates with a heavy material discharge formed in an end surface of the body opposite the flange.
